(19) United States
(12) Patent Application Publication
(10) Pub. No.: US 2010/0319121 A1
(43) Pub. Date: Dec. 23, 2010

(54) Maneuverable patient transfer device

(76) Inventors: Jeff Polomsky, Bristolville, OH (US); Russ Warren, Streetsboro, OH (US)

Correspondence Address: Richard L. Mikesell, Esq., Suite 216, 14827 Ventura Blvd., Sherman Oaks, CA, 91403, US

(21) Appl. No.: 12/456,547

(22) Filed: Jun. 19, 2009

(51) Int. Cl. A61G 7/05

(52) U.S. Cl. 5/81.1 RP

(57) ABSTRACT

A patient transfer device has an annular swivel ring rotatably mounted at one end of a base and located above a non-slip surface of that base, while the base rests on a support surface by means of a second non-slip surface. A hand-hold is located closely adjacent another end of the base so the overall device is stable and has a large non-slip surface presented both toward the user and toward the support surface; however, the device is not so large as to be cumbersome to maneuver. Thus, a balance has been made between stability and maneuverability and the locations of the hand-hold and the swivel are chosen to achieve this result. The covering of both the top and bottom surfaces of the base with non-slip material also permit the device to stably support a user while remaining as small and maneuverable as possible. The non-slip surface on the top surface is also located within the perimeter of the annular swivel ring to be easily and quickly accessible to the user so the user can easily stop the swivel at any time should he or she wish to stop moving for any reason by simply exerting pressure on his or her feet so they contact the non-slip surface located within the perimeter of the annular swivel ring.

### TECHNICAL FIELD OF THE INVENTION

The present invention relates to the general art of supports, and to the particular field of devices used to move patients.

### BACKGROUND OF THE INVENTION

Older and/or infirm people frequently experience limited movement of their limbs, physical instability, and reduced strength. These factors result in such persons experiencing great difficulty in transferring themselves in and out of bed. This is particularly the case in hospitals, nursing homes, and care centers where beds are considerably higher due to castors and elevating devices fixed to them.

Patients recovering from surgery or the like are also subject to difficulties in moving from and to a bed to and from a chair. Aiding a patient to be extracted from a chair to a bed or vice versa, and to aid the attendant in removing the patient from the chair or bed, and transferring them to a bed or chair usually involves lifting the patient from the chair or bed to a standing position, then having to turn, or, orient, or turn them, while in the stationary standing position, and aiding them in setting down on a bed or chair, or other convenience. It has been customary to lift the patient to a desired position, turn them 180°, and maneuver them to a sitting position on the edge of the bed or chair, and then aid them in laying or sitting down, and further maneuvering them to a desired position.

During this maneuver, especially in the act of turning the patient 180°, while in the erect position, with the patients weight on the floor, the patient's feet can easily become tangled, causing a problem in re-orienting the feet to conform to the turning motion of the body. In many cases, this is a very painful experience to the patient, and, in the case of a hip, or leg injury, serious damage to the injury can occur. In the case of patients with Alzheimer's disease, the patient becomes dis-oriented, and is unable to cooperate with the attendant, and a lengthy process ensues, with the attendant having the problem of holding the patient's weight during the turning of the feet. It is customary to have an additional attendant to accomplish this task.

Transfer of a physically impaired or disabled individual from one location to another can be a formidable task, especially when only one other person is available to assist in such transfer. This latter situation, of course, is often the case when the physically impaired individual is at home or in other non-institutional environments.

While the inventor is aware of several designs for devices that enable a patient to be turned 180° for movement from or to a bed from or to a chair or the like, the inventor is not aware of any device that is simple, easy to use, easy to store and easy to maneuver. Some of the known devices include stands or complicated motors or the like. Some of the devices may be so cumbersome that they require two people to maneuver them, which vitiates, if not totally defeats, the advantage of such devices.

Therefore, there is need for a device to orient a patient from facing one direction to facing another direction that is simple, easy to use, easy to store and easy to maneuver.

Still further, since the device will be used by a patient that is most probably infirm and very unsteady on their feet, the device should be as stable as possible.

Therefore, there is need for a device to orient a patient from facing one direction to facing another direction that is simple, easy to use, easy to store and easy to maneuver and yet is also stable in use.

### SUMMARY OF THE INVENTION

These, and other, objects are achieved by a patient transfer device which has an annular swivel ring rotatably mounted at one end of a base and located above a non-slip surface of that base, while the base rests on a support surface by means of a second non-slip surface. A hand-hold is located closely adjacent another end of the base so the overall device is stable and has a large non-slip surface presented both toward the user and toward the support surface; however, the device is not so large as to be cumbersome to maneuver. Thus, a balance has been made between stability and maneuverability and the locations of the hand-hold and the swivel are chosen to achieve this result. The covering of both the top and bottom surfaces of the base with non-slip material also permit the device to stably support a user while remaining as small and maneuverable as possible. The non-slip surface on the top surface is also located within the perimeter of the annular swivel ring to be easily and quickly accessible to the user so the user can easily stop the swivel at any time should he or she wish to stop moving for any reason by simply exerting pressure on his or her feet so they contact the non-slip surface located within the perimeter of the annular swivel ring.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWING FIGURE

The invention can be better understood with reference to the following drawing and description. The components in the figure are not necessarily to scale, emphasis instead being placed upon illustrating the principles of the invention. Moreover, in the figure, like referenced numerals designate corresponding parts throughout the different view.

FIG. 1 is a perspective view of a patient transfer device embodying the principles of the present invention.

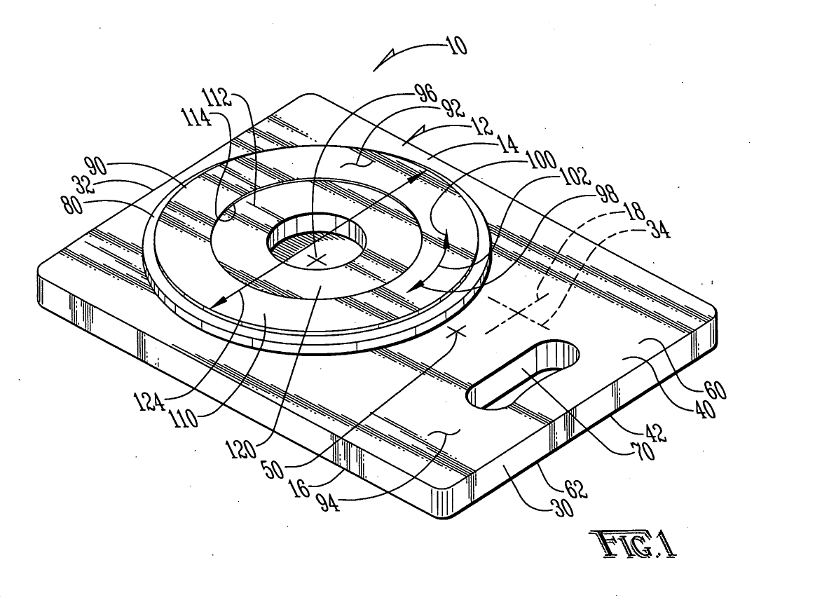

### DETAILED DESCRIPTION OF THE INVENTION

Referring to the figure, it can be understood that the present invention is embodied in a patient transfer device 10 which comprises a rectangular base 12 having a first side 14, a second side 16 and a transverse axis 18 which extends between the first side and second side. Base 12 further includes a first end 30, a second end 32 and a longitudinal axis 34 which extends between the first end and the second end. A first planar surface 40 is a top surface when the base is in use and which is presented upwardly toward a user when the base is in use, with the use orientation of the device being shown in the figure. A second planar surface 42 is a bottom surface when the base is in use and contacts a supporting surface, such as a floor adjacent to a bed, when the base is in use. Base 12 has a center of gravity 50.

A first non-stick surface 60 completely covers first surface 40 and a second non-stick surface 62 completely covers second surface 42 to contact the supporting surface when the base is in use whereby the base is stabilized on the supporting surface.

A hand-hold hole 70 is arcuate and extends in the direction of the transverse axis of the base. The hand-hold is defined through the base from first surface 40 to second surface 42 adjacent to first end 30 of the base. The end location of the hand-hold makes the device easy to handle and maneuver.

A mounting ring 80 is securely mounted on first surface 40 of the base adjacent to second end 32 of the base, and an annular swivel ring 90 is rotatably mounted on mounting ring 80 as by ball bearings or the like to rotate in a plane 92 that is parallel to a plane 94 containing first surface 40 of the base. Swivel ring 90 rotates about a center 96 thereof in directions 98 and 100 as indicated by double-headed arrow 102. Annular swivel ring 90 has an annular first surface 110 on which the user stands for use and a circular area 112 defined within perimeter 114 of the annular swivel ring.

First non-stick surface 60 has a portion 120 thereof located in the circular area to be located for contact with the feet of a user standing on the swivel ring to stop movement of the swivel ring by contact between the feet of the user and the first non-stick surface.

The mounting ring and the hand-hold are spaced apart in the direction of the longitudinal axis of the base a distance sufficient to space center of gravity 50 of the base apart from center 96 of the swivel ring and between the swivel ring and the hand-hold. This spacing has been selected to allow the overall device to be small enough to be easily maneuvered, yet to be stable in use.

Still further, the size of the swivel ring has a diameter 124 which is only slightly smaller than the width dimension of the base as measured along the transverse axis of the base whereby when a user stands on the swivel ring, he or she is stably and securely supported, yet the overall dimensions of the base are not too large so as to make the device easily maneuverable.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

What is claimed is:

1. A patient transfer device comprising:
a rectangular base having
a first side,
a second side,
a transverse axis which extends between the first side and second side,
a first end,
a second end,
a longitudinal axis which extends between the first end and the second end,
a first planar surface which is a top surface when the base is in use and which is presented upwardly toward a user when the base is in use,
a second planar surface which is a bottom surface when the base is in use and which contacts a supporting surface when the base is in use, and
a center of gravity;
a first non-stick surface completely covering the first surface;
a second non-stick surface completely covering the second surface to contact the supporting surface when the base is in use whereby the base is stabilized on the supporting surface;
a hand-hold hole defined through the base from the first surface to the second surface adjacent to the first end of the base;
a mounting ring securely mounted on the first surface of the base adjacent to the second end of the base;
an annular swivel ring rotatably mounted on the mounting ring to rotate in a plane that is parallel to a plane containing the first surface of the base, the annular swivel ring having a center and an annular first surface on which the user stands for use and a circular area defined within the perimeter of the annular swivel ring;
the first non-stick surface having a portion thereof located in the circular area to be located for contact with the feet of a user standing on the swivel ring to stop movement of the swivel ring by contact between the feet of the user and the first non-stick surface;
the mounting ring and the hand-hold being spaced apart in the direction of the longitudinal axis of the base a distance sufficient to space the center of gravity of the base apart from the center of the swivel ring and between the swivel ring and the hand-hold.

2. The patient transfer device defined in claim 1 further including a third non-slip surface on the first surface of the swivel ring.

3. The patient transfer device defined in claim 2 wherein the base has a width dimension defined along the transverse axis between the first side and the second side, and the swivel ring has a diameter which is just slightly smaller than the width dimension.

4. A patient transfer device consisting essentially entirely of:
a rectangular base having
a first side,
a second side,
a transverse axis which extends between the first side and second side,
a first end,
a second end,
a longitudinal axis which extends between the first end and the second end,
a first planar surface which is a top surface when the base is in use and which is presented upwardly toward a user when the base is in use,
a second planar surface which is a bottom surface when the base is in use and which contacts a supporting surface when the base is in use, and
a center of gravity;
a first non-stick surface completely covering the first surface;
a second non-stick surface completely covering the second surface to contact the supporting surface when the base is in use whereby the base is stabilized on the supporting surface;
a hand-hold hole defined through the base from the first surface to the second surface adjacent to the first end of the base;
a mounting ring securely mounted on the first surface of the base adjacent to the second end of the base;
an annular swivel ring rotatably mounted on the mounting ring to rotate in a plane that is parallel to a plane containing the first surface of the base, the annular swivel ring having a center and an annular first surface on which the user stands for use and a circular area defined within the perimeter of the annular swivel ring;
the first non-stick surface having a portion thereof located in the circular area to be located for contact with the feet of a user standing on the swivel ring to stop movement of the swivel ring by contact between the feet of the user and the first non-stick surface;
a third non-slip surface on the first surface of the swivel ring;
the mounting ring and the hand-hold being spaced apart in the direction of the longitudinal axis of the base a distance sufficient to space the center of gravity of the base apart from the center of the swivel ring and between the swivel ring and the hand-hold; and
the base having a width dimension defined along the transverse axis between the first side and the second side, and the swivel ring having a diameter which is just slightly smaller than the width dimension.
